(19) United States
(12) Patent Application Publication
(10) Pub. No.: US 2019/0050382 A1
(43) Pub. Date: Feb. 14, 2019

(54) METHOD OF ROW GROUPING AND DATA MANAGEMENT SERVER

(71) Applicant: EMRO CO., LTD., Seoul (KR)

(72) Inventor: Ho Jin HWANG, Seoul (KR)

(21) Appl. No.: 15/692,630

(22) Filed: Aug. 31, 2017

(30) Foreign Application Priority Data
Aug. 11, 2017 (KR) 10-2017-0102204

(51) Int. Cl. G06F 17/24; G06F 3/0486; G06F 17/30

(52) U.S. Cl. CPC G06F 17/245; G06F 17/30601; G06F 17/243; G06F 3/0486

(57) ABSTRACT

Provided is a method of grouping rows of a table in a data management server. The method includes: receiving a grouping setting request for a first column through an operation page provided to a user terminal; performing a grouping operation to group rows having the same field value of the first column into a row group; and processing the row group generated through the field value of the first column to be displayed on the operation page.

### CROSS-REFERENCE TO RELATED APPLICATION

This application claims priority to and the benefit of Korean Patent Application No. 2017-0102204, filed on Aug. 11, 2017, the disclosure of which is incorporated herein by reference in its entirety.

### BACKGROUND

### 1. Field of the Invention

The present invention relates to a method of row grouping and a data management server, and more specifically, to a method of row grouping and a data management server in which, when a header of a column is dragged into a grouping panel area on an operation page provided to a user terminal, rows having the same field value of the column are grouped into a row group and the row group generated through the field value of the column is processed to be displayed on the operation page.

### 2. Discussion of Related Art

As computer use becomes more widespread, the amount of data to be processed is increasing exponentially.

In order to manage a large amount of data, a worksheet program, such as Excel, is used, which has difficulties in managing a data set consisting of a plurality of columns and rows.

When data is managed by dividing the data set consisting of a plurality of columns and rows into groups, it takes a long period of time for a user to perform grouping by manually specifying rows to be grouped, and thus productivity of a grouping operation is lowered.

Therefore, there is an increasing demand for increasing user convenience and productivity by simplifying a grouping operation on the data set consisting of a plurality of rows and columns. In addition, there is an urgent need for a solution to solve the above problems.

### SUMMARY OF THE INVENTION

The present invention is made to solve the above-described problems of the related art, and one objective of the present invention is to provide a method of row grouping and a data management server in which, when a header of a column is dragged into a grouping panel area in an operation page provided to a user terminal, rows having the same field value of the column are grouped into a row group and the row group generated through the field value of the column is processed to be displayed on the operation page.

However, the objective of the present invention is not limited to the above description and various other objectives can be clearly understood by those skilled in the art from the following description. In one general aspect, there is provided a method of grouping rows of a table in a data management server, the method including: receiving a grouping setting request for a first column through an operation page provided to a user terminal; performing a grouping operation to group rows having the same field value of the first column into a row group; and processing the row group generated through the field value of the first column to be displayed on the operation page.

The receiving of the grouping setting request may include receiving the grouping setting request for the first column when a header of the first column is dragged into a grouping panel area in the operation page.

The method may further include, when the header of the first column is deleted from the grouping panel area, processing rows ungrouped from the row group generated through the field value of the first column to be displayed on the operation page.

The method may further include, when receiving a grouping setting request for a second column, performing a grouping operation to group rows having the same field value of the second column into a row group while the rows have been grouped through the field value of the first column, and processing the row group generated through the field values of the first column and the second column to be displayed on the operation page.

The processing of the row group may include processing at least one of the number of fields included in the row group and the sum of field values to be further displayed at a top or a bottom of the row group.

In another general aspect, there is provided a data management server including: a request receiver configured to receive a grouping setting request for a first column through an operation page provided to a user terminal; a grouping unit configured to perform a grouping operation to group rows having the same field value of the first column into a row group; and a display processor configured to process the row group generated through the field value of the first column to be displayed on the operation page.

The request receiver may receive the grouping setting request for the first column when a header of the first column is dragged into a grouping panel area in the operation page.

When the header of the first column is deleted from the grouping panel area, the display processor may process rows ungrouped from the row group generated through the field value of the first column to be displayed on the operation page.

The request receiver may receive a grouping setting request for a second column, the grouping unit may perform a grouping operation to group rows having the same field value of the second column into a row group, and the display processor may process the row group generated through the field values of the first column and the second column to be displayed in the operation page.

The display processor may process at least one of the number of fields included in the row group and the sum of field values to be further displayed at a top or a bottom of the row group.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a data management system according to one embodiment of the present invention;

FIG. 2 is a block diagram illustrating a configuration of a data management server 200 according to one embodiment of the present invention;

FIG. 3 is a diagram illustrating an operation page on which a data set formed as a table is displayed according to one embodiment of the present invention;

FIG. 4 is a diagram illustrating an operation page on which a data set in which grouping is performed through field values of a first column is displayed according to one embodiment of the present invention; and

FIG. 5 is a diagram illustrating an operation page on which a data set in which grouping is performed through field values of the first column and a second column is displayed according to one embodiment of the present invention.

### DETAILED DESCRIPTION OF EXEMPLARY EMBODIMENTS

The present invention will be described more fully hereinafter with reference to the accompanying drawings, in which exemplary embodiments of the invention are shown. The present invention may, however, be embodied in many different forms and should not be construed as being limited to the embodiments set forth herein. Also, irrelevant details have been omitted from the drawings for increased clarity and conciseness, and similar parts are indicated by similar reference numerals throughout the detailed description.

Throughout the specification, it will be understood that when an element is referred to as being “connected to” another element, it can be directly connected to the other element, or intervening elements may be present. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

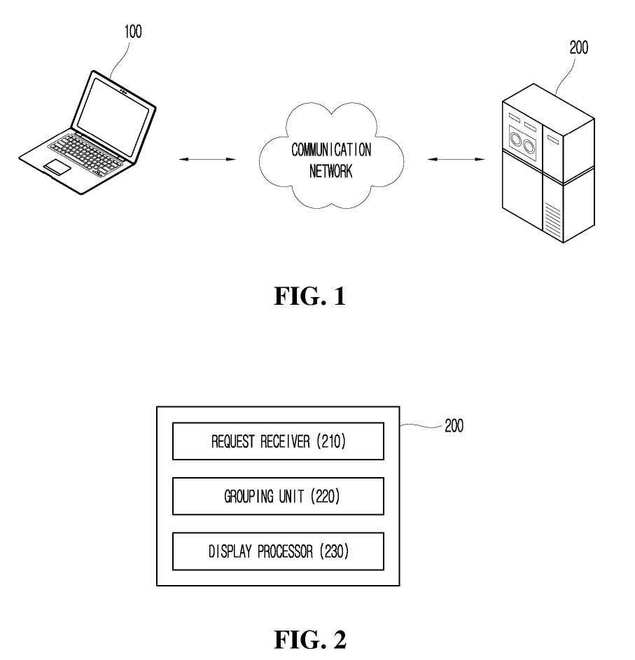

FIG. 1 is a diagram illustrating a data management system according to one embodiment of the present invention.

Referring to FIG. 1, the data management system according to one embodiment of the present invention may include a user terminal 100 and a data management server 200 which may communicate with each other through a communication network.

The communication network may be configured without regard to its communication mode, such as wired and wireless, and may be configured as various communication networks, such as a local area network (LAN), a metropolitan area network (MAN), a wide area network (WAN), and the like.

The user terminal 100 may include any type of handheld based wireless communication device connectable to an external server through a wireless communication network, such as a mobile phone, a smartphone, a personal digital assistant (PDA), a portable multimedia player (PMP), or a tablet PC. In addition, the user terminal 100 may include any communication devices connectable to an external server through a network, such as a desktop PC, a tablet PC, a laptop PC, and an IPTV including a set-top box.

The user terminal 100 may access the data management server 200 through an application or a web browser and be provided with a data management service. In this case, the data management server 200 may provide the data management service to the user terminal 100 by providing an operation page for data editing.

The user terminal 100 may display the operation page provided from the data management server 200 on a screen and further display a data set formed as a table on the operation page. In this case, the data set may be manually input by a user or obtained from a previously stored file, and may be displayed in a data area provided on a portion of the operation page.

When a first column is selected from columns of the table on the operation page for grouping rows of the table, the user terminal 100 may transmit a grouping setting request for the first column to the data management server 200.

When a grouping operation for the first column is performed by the data management server 200, the user terminal 100 may display the row groups generated through field values of the first column on the operation page.

The data management server 200 may provide the operation page for data editing to the user terminal 100. When grouping setting for the first column is requested on the operation page, the data management server 200 may receive request of grouping setting for the first column and perform a grouping operation to group the rows having the same field values of the first column.

FIG. 2 is a block diagram illustrating a configuration of a data management server 200 according to one embodiment of the present invention.

Referring to FIG. 2, the data management server 200 includes a request receiver 210, a grouping unit 220, and a display processor 230.

Hereinafter, the configuration of the data management server 200 will be described in detail with reference to the operation of grouping rows of a table.

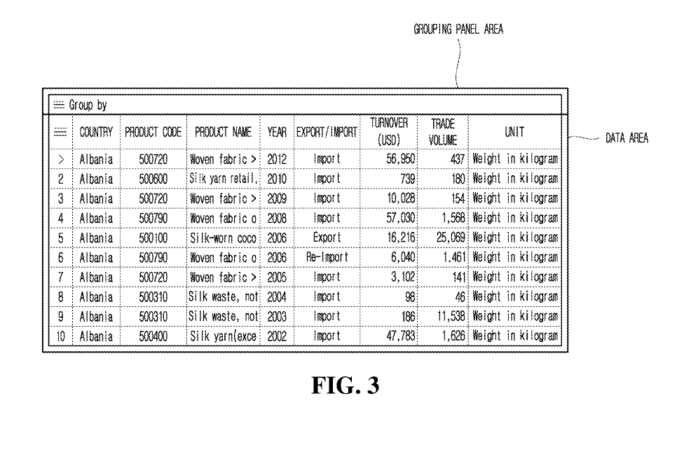

First, the data management server 200 may provide an operation page for data editing to the user terminal 100. In this case, the data management server 200 may provide the operation page implemented as a worksheet, and the operation page may include a data area in which a data set is displayed and a grouping panel area in which grouping setting is displayed. Details related to this operation will be described with reference to FIG. 3.

FIG. 3 is a diagram illustrating an operation page on which a data set formed as a table is displayed according to one embodiment of the present invention.

As shown in FIG. 3, the data management server 200 may provide a portion of the operation page as a data area and another portion as a grouping panel area. For example, the data area is located at the bottom of the operation page and the displayed area may be wide. The grouping panel area may be located at the top of the operation page and the displayed area may be narrow.

A data set formed as a table may be displayed in the data area of the operation page. In this case, the data set may be formed as a table consisting of a plurality of rows and columns and may be manually input by the user or obtained from a previously stored file.

When a first column is selected from columns of the table, the request receiver 210 may receive a grouping setting request for the first column through the operation page provided to the user terminal 100.

For example, the table of the data set may be composed of columns, such as “Country,” “Product Code,” “Product Name,” “Year,” “Export/Import,” “Turnover,” “Unit,” and the like, and when the “Country” column is selected, the request receiver 210 may receive a grouping setting request for the “Country” column.

When a header of the first column is dragged into the grouping panel area in the operation page in the process of grouping setting for the first column, the request receiver 210 may receive the grouping setting request for the first column.

For example, when a header of the “Country” column displayed in the data area is dragged into the grouping panel area, the request receiver 210 may receive a grouping setting request for the “Country” column.

According to one embodiment of the present invention, when a menu formed in a portion of the grouping panel area is selected, columns of the data set may be displayed through the menu. In this case, when the first column is selected from the displayed columns, the request receiver 210 may receive a grouping setting request for the first column.

For example, when a menu is provided at the top left of the grouping panel area and the menu is selected, columns, such as “Country,” “Product Code,” “Product Name,” “Year,” “Export/Import,” “Turnover,” “Unit,” and the like, may be displayed. When the “Country” column is selected from the displayed columns, the request receiver 210 may receive a grouping setting request for the “Country” column.

The grouping unit 220 may perform a grouping operation for the first column in response to the grouping setting request for the first column received in the request receiver 210.

Specifically, the grouping unit 220 may perform the grouping operation by grouping the rows having the same field values of the first column. For example, field values of the “Country” column are checked and rows, such as “Albania,” “Korea,” “Japan,” and the like, which have the same field value, may be grouped into row groups, such as the “Albania” row group, “Korea” row group, “Japan” row group, and the like.

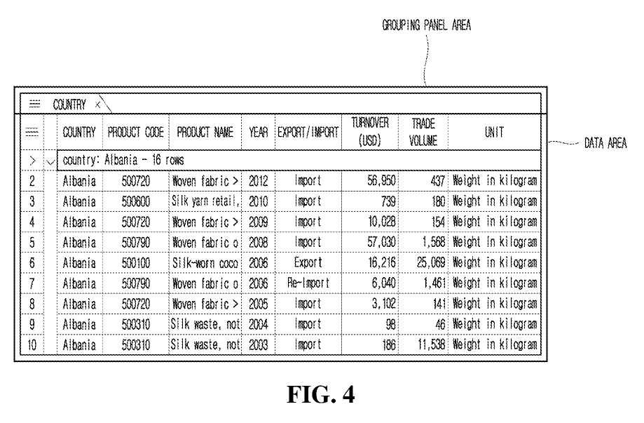

When the grouping unit 220 completes the grouping through the field values of the first column, the display processor 230 may process the row groups, which are grouped through the field value of the first column, to be displayed on the operation page. Details related to this operation will be described with reference to FIG. 4.

FIG. 4 is a diagram illustrating an operation page on which a data set in which grouping is performed through field values of a first column is displayed according to one embodiment of the present invention.

First, when a header of the first column displayed in the data area is dragged into the grouping panel area, the header of the first column may be displayed in the grouping panel area, as shown in FIG. 4, and the request receiver 210 may receive a grouping setting request for the first column.

Then, the grouping unit 220 may perform a grouping operation to group the rows having the same field values of the first column, and the display processor 230 may process the row groups generated through the field values of the first column to be displayed in the data area of the operation page.

For the sake of convenience, FIG. 4 shows only a part of a data set, wherein only the “Albania” row group among the field values of the first column is displayed in the data area of the operation page. When the user scrolls downward, other row groups, such as the “Korea” row group, “Japan” row group, and the like, may be further displayed.

According to one embodiment of the present invention, the display processor 230 may process at least one of the number of fields included in the row group and the sum of field values to be further displayed at the top or bottom of the row group.

For example, when the number of “Albania” is 16, which is obtained by checking field values of the “Country” column of the data set, the grouping unit 220 may group 16 rows into the “Albania” row group, and the display processor 230 may process the number of fields, 16, to be displayed at the top of the “Albania” row group, as shown in FIG. 4.

In the case where the “Turnover” column and “Trade Volume” column have numerical values when field values contained in each column of the data set are checked, the display processor 230 may process both the sum of field values included in the “Turnover” column of the “Albania” row group and the sum of field values included in the “Trade Volume” column to be displayed at the bottom of the “Albania” row group.

In addition, although not illustrated in FIG. 4, the display processor 230 may process at least one of the number of fields included in a row group and a sum of field values to be further displayed at the top or bottom of each of other row groups, such as “Korea” row group, “Japan” row group, and the like.

When the header of a first column is deleted from the grouping panel area, the display processor 230 may process the rows ungrouped from the row group generated through the field value of the first column to be displayed on the operation page.

For example, when “Country” which is a header of a first column is deleted from the grouping panel area shown in FIG. 4, the display processor 230 may perform ungrouping and process ungrouped rows to be displayed in the data area on the operation page, as shown in FIG. 3.

That is, when a header of the first column is added to the grouping panel area, ungrouped rows may be grouped into a row group through the field value of the first column so that the row group may be displayed in the data area. When the header of the first column displayed in the grouping panel area is deleted, the row group is converted to be ungrouped and the ungrouped rows may be displayed in the data area.

As shown in FIG. 4, when a header of a second column is dragged into the grouping panel area in the state where the rows are grouped through the field values of the first column, the request receiver 210 may receive a grouping setting request for the second column.

For example, when “Product Code” which is a header of the second column is dragged into the grouping panel area while “Country” which is a header of the first column is being displayed in the grouping panel area, the request receiver 210 may receive a grouping setting request for “Product Code” column.

The grouping unit 220 may perform a grouping operation for the second column in response to the grouping setting request for the second column received in the request receiver 210.

Specifically, the data set in which grouping has been performed through the field values of the first column includes a plurality of row groups. In this case, the grouping unit 220 may further perform a grouping operation on each of the row groups to group the rows having the same field values of the second column.

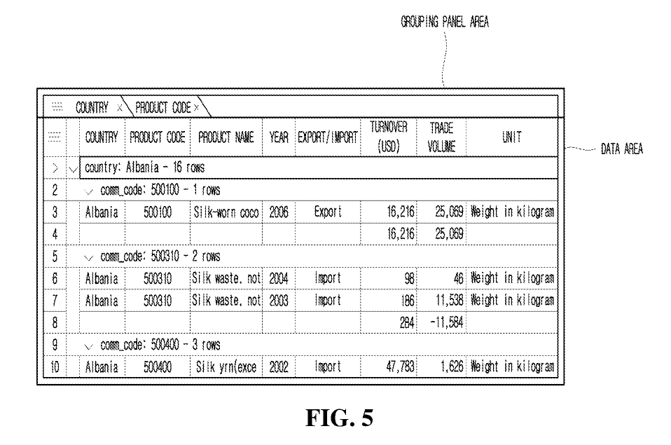

When the grouping unit 220 completes the grouping operation through the field values of the first column and second column, the display processor 230 may process the row group generated through the field values of the first column and the second column to be displayed on the operation page. Details related to this operation will be described with reference to FIG. 5.

FIG. 5 is a diagram illustrating an operation page on which a data set in which grouping is performed through field values of the first column and a second column is displayed according to one embodiment of the present invention.

First, as shown in FIG. 4, when the header of the second column is dragged into the grouping panel area while the header of the first column is being displayed in the grouping panel area, the header of the second column may be added to and further displayed in the grouping panel area, as shown in FIG. 5, and the request receiver 210 may receive a grouping setting request for the second column.

For example, when a header of the “Product Code” column is additionally dragged into the grouping panel area while a header of the “Country” column is located in the grouping panel area, the request receiver 210 may receive a grouping setting request for the “Product Code” column.

Then, the grouping unit 220 may further perform a grouping operation on each of row groups generated through the field values of the first column to group the rows having the same field values of the second column.

For example, the grouping unit 220 may perform a grouping operation on each of the “Albania” row group, “Korea” row group, and “Japan” row group, which are grouped through the field values of the first column, so that the rows having the same field values of the second column are grouped.

Specifically, the grouping unit 220 may check field values of the “Product Code” column and may group the rows having the same field values, such as “500100,” “500310,” “500400,” and the like, and may further group the “Albania” row group into a “500100” row group, “500310” row group, “500400” row group, and the like.

In addition to the “Albania” row group, the grouping unit 220 may further group rows in each of the “Korea” row group and “Japan” row group into a “500100” row group, “500310” row group, “500400” row group, and the like.

That is, the grouping unit 220 may hierarchically perform grouping on the data set according to the number of columns. For example, when it is assumed that the “Albania” row group is a first group, the “Korea” row group is a second group and the “Japan” row group is a third group, which are grouped through the field values of the first column, rows in the first group may be further grouped into a first-1 group which is a “500100” row group, a first-2 group which is a “500310” row group, and a first-3 group which is a “500400” row group, which are grouped through the field value of the second column. In the same manner, rows in the second group may be further grouped into a second-1 group, a second-2 group, and a second-3 group, and the rows in the third group may be further grouped into a third-1 group, a third-2 group, and a third-3 group.

When the grouping unit 220 completes the hierarchical grouping operation through the fields value of the first column and the second column, the display processor 230 may process the row groups, which are grouped through the field values of the second column while being in a grouped state through the field values of the first column, to be displayed in the data area of the operation page.

For the sake of convenience, FIG. 5 shows only a part of the data set, wherein only a result of grouping the “Albania” row group among the field values of the first column according to “500100”, “500310” and “500400” which are field values of the second column is displayed in the data area of the operation page. When the user scrolls downward, the result of grouping other row groups, such as the “Korea” row group, “Japan” row group, and the like, according to the field values of the second column will be further displayed.

According to one embodiment of the present invention, the display processor 230 may process at least one of the number of fields included in the row group and the sum of field values to be displayed at the top or bottom of each of the hierarchically grouped row groups.

For example, when the number of “Albania” which is a field value included in the “Country” column is 16, 16, which is the number of fields, may be displayed at the top of “Albania” row group, and when the number of “500100” which is a field value included in the “Product Code” column within “Albania” row group is 1, 1, which is the number of fields, may be displayed at the top of the “500100” row group. In addition, when the number of “500310” is 2, 2, which is the number of fields, may be displayed at the top of the “500310” row group, and when the number of “500400” is 3, 3, which is the number of fields may be displayed at the top of the “500400” row group.

In the case where the “Turnover” column and “Trade Volume” column have numerical values when field values contained in each column of the data set are checked, the display processor 230 may process both the sum of field values included in the “Turnover” column in the “Albania” row group and the sum of field values included in the “Trade Volume” column to be displayed at the bottom of the “Albania” row group, process both the sum of field values included in the “Turnover” column in the “500100” row group within the “Albania” row group and the sum of field values included in the “Trade Volume” column to be displayed at the bottom of the “500100” row group, process both the sum of field values included in the “Turnover” column in the “500310” row group within the “Albania” row group and the sum of field values included in the “Trade Volume” column to be displayed at the bottom of the “500310” row group, and process both the sum of field values included in the “Turnover” column in the “500400” row group within the “Albania” row group and the sum of field values included in the “Trade Volume” column to be displayed at the bottom of the “500400” row group.

In addition, although not illustrated in FIG. 5, the display processor 230 may process at least one of the number of fields included in a row group and a sum of field values to be further displayed at the top or bottom of each of other row groups, such as the “Korea” row group, “Japan” row group, and the like.

When a header of either the first column or the second column is deleted from the grouping panel area, the display processor 230 may process the rows ungrouped from the row group generated through the field value of the deleted column to be displayed on the operation page.

For example, when “Country” which is a header of the first column is deleted from the grouping panel area shown in FIG. 5, the display processor 230 may perform ungrouping on the “Country” column and process the row groups generated through the field values of the “Product Code” column, which is the second column, to be displayed.

In addition, when “Product Code” which is a header of the second column is deleted from the grouping panel area, the display processor 230 may perform ungrouping on the “Product Code” column and process the row groups generated through the field values of the “Country” column, which is the first column, to be displayed.

As described above, according to the embodiments of the present invention, only by dragging a header of a column, it is possible to display row groups generated through field values of the column, thereby facilitating data grouping and increasing user convenience.

However, the effects of the present invention are not limited to the effects described above, and other effects that have not been set forth herein will be clearly understood from the detailed description of the present invention or the appended claims by those skilled in the art.

The foregoing description of the invention is for illustrative purposes and a person having ordinary skilled in the art will appreciate that other specific modifications can be easily made without departing from the technical spirit or essential features of the invention. Therefore, the foregoing embodiments should be regarded as illustrative rather than limiting in all aspects. For example, some components, each of which has been described as being a single form, can be embodied in the distributed form, whereas some components, which have been described as being distributed, can be embodied in the combined form.

The scope of the present invention is not defined by the detailed description as set forth above but by the accompanying claims of the invention. It should also be understood that all changes or modifications derived from the definitions and scopes of the claims and their equivalents fall within the scope of the invention.

What is claimed is:

1. A method of grouping rows of a table in a data management server, the method comprising:
receiving a grouping setting request for a first column through an operation page provided to a user terminal;
performing a grouping operation to group rows having the same field value of the first column into a row group; and
processing the row group generated through the field value of the first column to be displayed on the operation page.

2. The method of claim 1, wherein the receiving of the grouping setting request includes receiving the grouping setting request for the first column when a header of the first column is dragged into a grouping panel area in the operation page.

3. The method of claim 2, further comprising:
when the header of the first column is deleted from the grouping panel area, processing rows ungrouped from the row group generated through the field value of the first column to be displayed on the operation page.

4. The method of claim 1, further comprising:
when receiving a grouping setting request for a second column, performing a grouping operation to group rows having the same field value of the second column into a row group while the rows have been grouped through the field value of the first column, and processing the row group generated through the field values of the first column and the second column to be displayed on the operation page.

5. The method of claim 1, wherein the processing of the row group includes processing at least one of a number of fields included in the row group and a sum of field values to be further displayed at a top or a bottom of the row group.

6. A data management server comprising:
a request receiver configured to receive a grouping setting request for a first column through an operation page provided to a user terminal;
a grouping unit configured to perform a grouping operation to group rows having the same field value of the first column into a row group; and
a display processor configured to process the row group generated through the field value of the first column to be displayed on the operation page.

7. The data management server of claim 6, wherein the request receiver receives the grouping setting request for the first column when a header of the first column is dragged into a grouping panel area in the operation page.

8. The data management server of claim 7, wherein, when the header of the first column is deleted from the grouping panel area, the display processor processes rows ungrouped from the row group generated through the field value of the first column to be displayed on the operation page.

9. The data management server of claim 6, wherein the request receiver receives a grouping setting request for a second column, the grouping unit performs a grouping operation to group rows having the same field value of the second column into a row group and the display processor processes the row group generated through the field values of the first column and the second column to be displayed on the operation page.

10. The data management server of claim 6, wherein the display processor processes at least one of a number of fields included in the row group and a sum of field values to be further displayed at a top or a bottom of the row group.
